(19) United States
(12) Patent Application Publication
(10) Pub. No.: US 2019/0063733 A1
(43) Pub. Date: Feb. 28, 2019

(54) PORTABLE ILLUMINATION ASSEMBLY

(71) Applicant: Jerry Carson, Pflugerville, TX (US)

(72) Inventor: Jerry Carson, Pflugerville, TX (US)

(21) Appl. No.: 15/690,492

(22) Filed: Aug. 30, 2017

(51) Int. Cl. F21V 21/088; F21L 4/08; F21V 23/04; F21V 33/00

(52) U.S. Cl. CPC F21V 21/0885; F21V 33/008; F21V 23/0414; F21L 4/08

(57) ABSTRACT

A portable illumination assembly for employing the power equipment in a dark environment includes a clip that is manipulated to engage a tubular structure. A plurality of light emitters is each coupled to the clip. Each of the light emitters selectively emits light outwardly therefrom thereby facilitating the light emitters to illuminate a darkened environment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to illumination devices and more particularly pertains to a new illumination device for employing the power equipment in a dark environment.

### BRIEF SUMMARY OF THE INVENTION

An embodiment of the disclosure meets the needs presented above by generally comprising a clip that is manipulated to engage a tubular structure. A plurality of light emitters is each coupled to the clip. Each of the light emitters selectively emits light outwardly therefrom thereby facilitating the light emitters to illuminate a darkened environment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a portable illumination assembly according to an embodiment of the disclosure.

FIG. 2 is a bottom view of an embodiment of the disclosure.

FIG. 3 is a back phantom view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

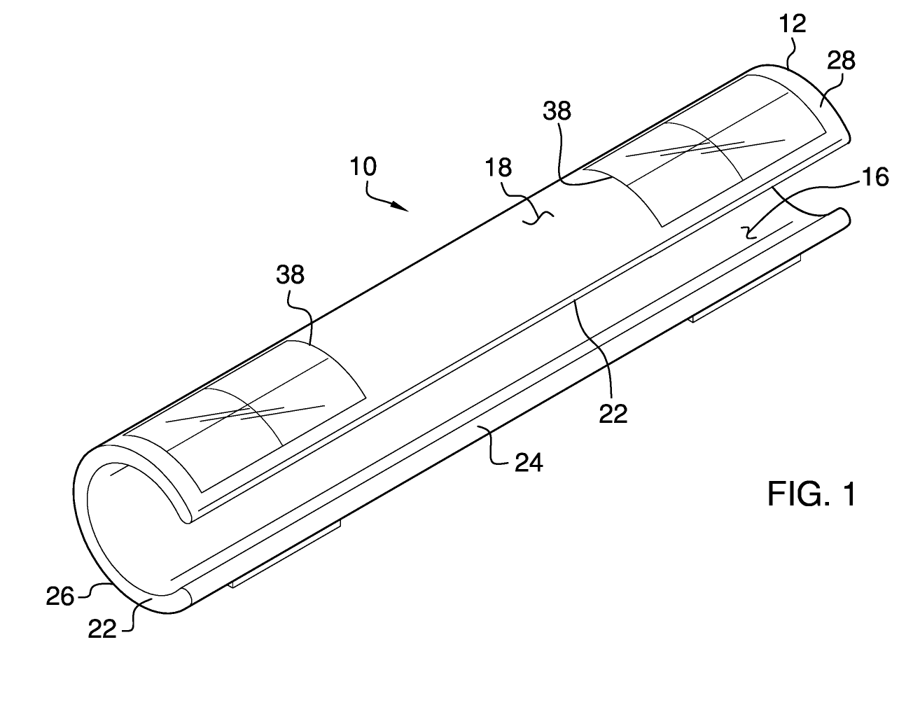

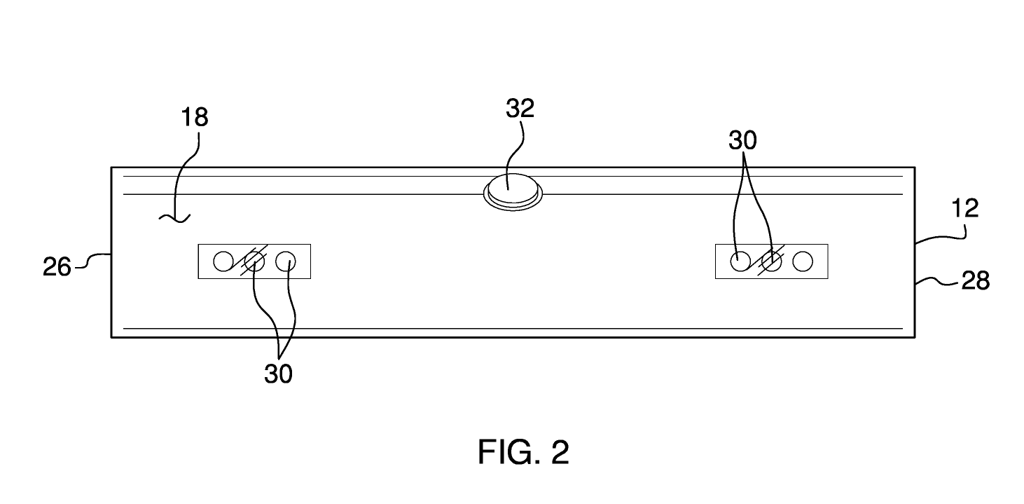

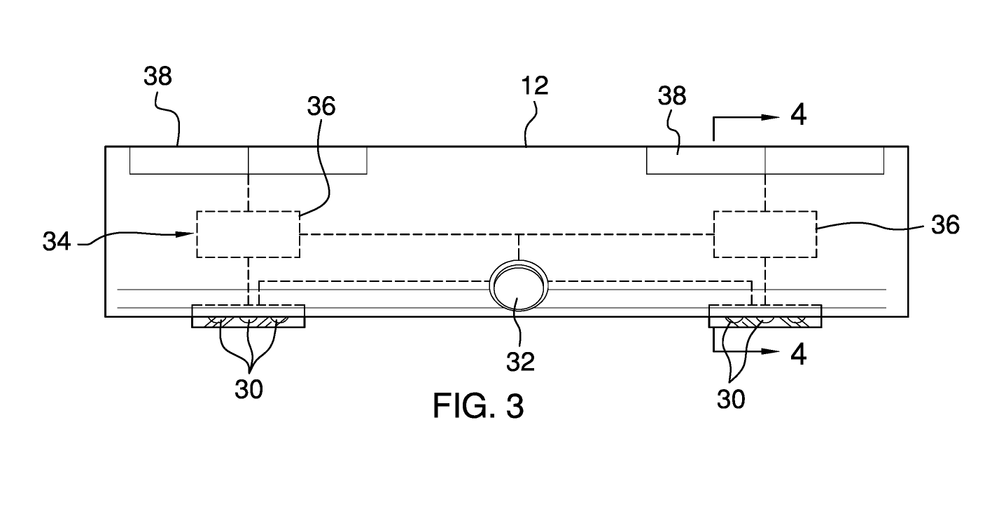

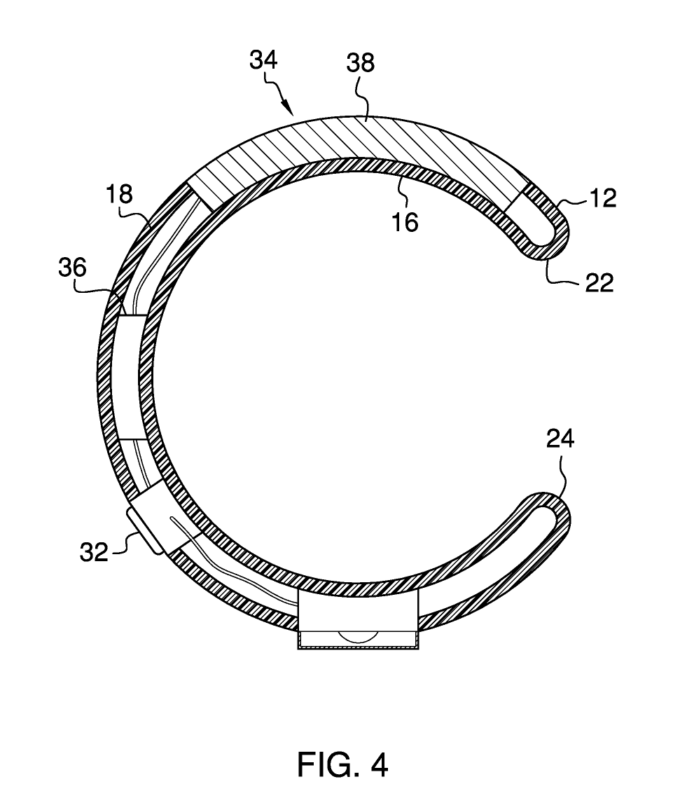

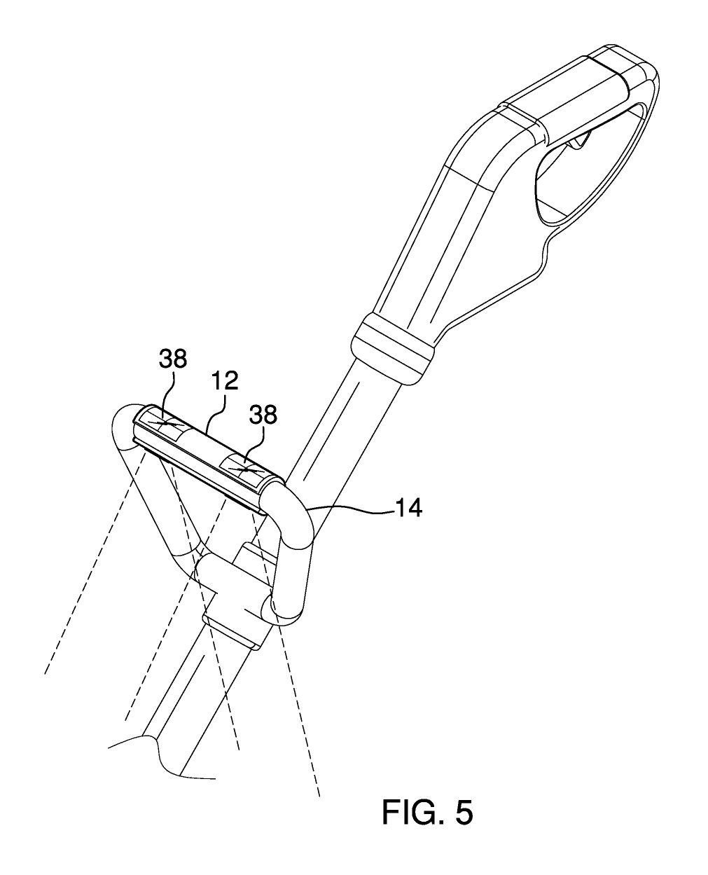

With reference now to the drawings, and in particular to FIGS. 1 through 5 thereof, a new illumination device embodying the principles and concepts of an embodiment of the disclosure and generally designated by the reference numeral 10 will be described.

As best illustrated in FIGS. 1 through 5, the portable illumination assembly 10 generally comprises a clip 12 that selectively engages a tubular structure 14. The tubular structure 14 may be a handle on a power tool, such as a weed eater or the like. Additionally, the tubular structure 14 may be a handle on a cart or any other tubular structure 14. The clip 12 has a first surface 16, a second surface 18 and a peripheral edge 20 extending therebetween. The peripheral edge 20 has a front side 22, a back side 24, a first lateral side 26 and a second lateral side 28. Additionally, the clip 12 may be substantially hollow.

The clip 12 is elongated between the first 26 and second 28 lateral sides. The clip 12 is concavely arcuate between the front side 22 and the back side 24 such that the clip 12 forms a tube having the front side 22 being spaced from the back side 24. The clip 12 is comprised of a resiliently bendable material such that the front side 22 is selectively urged away from the back side 24. In this way the clip 12 receives the tubular structure 14 having the first surface 16 of the clip 12 abutting the tubular structure 14.

A plurality of light emitters 30 is provided and each of the light emitters 30 is coupled to the clip 12. Each of the light emitters 30 emits light outwardly therefrom thereby facilitating the light emitters 30 to illuminate a darkened environment. Moreover, each of the light emitters 30 is positioned on the second surface 18 of the clip 12. The light emitters 30 are spaced apart from each other and are distributed on the back side 24 of the clip 12. Thus, each of the light emitters 30 is directed downwardly when the clip 12 is removably attached to the tubular structure 14. Each of the light emitters 30 may comprise an LED or the like. Moreover, each of the light emitters 30 may be positioned within a housing and a lens may be positioned over each of the light emitters 30.

A button 32 is movably coupled to the second surface 18 of the clip 12. Each of the light emitters 30 is electrically coupled to the button 32 such that the button 32 turns the light emitters 30 on and off. A power supply 34 is coupled to the clip 12 and each of the light emitters 30 is electrically coupled to the power supply 34. The power supply 34 comprises at least one battery 36 that is positioned between the first surface 16 and the second surface 18 of the clip 12. Each of the light emitters 30 is electrically coupled to the at least one battery 36. The at least one battery 36 may be a rechargeable battery of any conventional design.

A plurality of solar panels 38 is provided and each of the solar panels 38 is coupled to the clip 12. Each of the solar panels 38 is selectively exposed to sunlight to convert sunlight into electrical current. Each of the solar panels 38 is electrically coupled to at least one battery 36 to charge the at least one battery 36. Each of the solar panels 38 is positioned on the second surface 18 of the clip 12. Moreover, each of the solar panels 38 is spaced apart from each other and is distributed along the front side 22 of the clip 12. Thus, each of the solar panels 38 is directed upwardly when the clip 12 is removably attached to the tubular structure 14.

In use, the clip 12 is removably coupled to the tubular structure 14 such that the back side 24 of the clip 12 is positioned on a bottom of the tubular structure 14 and the front side 22 of the clip 12 is positioned on the top of the tubular structure 14. In this way the light emitters 30 are directed downwardly and the solar panels 38 are directed upwardly. Thus, the solar panels 38 are exposed to sunlight to charge the at least one battery 36. The button 32 is selectively depressed to turn the light emitters 30 on. Thus, the power tool, the cart and any other object with a rounded handle may be employed in a darkened environment. The plurality of light emitters 30 emits light downwardly to illuminate the ground and other objects.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable illumination assembly being configured to be removably attached to power equipment for employing the power equipment in a dark environment, said assembly comprising:
a clip being configured to engage a tubular structure, said clip having a first surface, a second surface and a peripheral edge extending therebetween, said peripheral edge having a front side, a back side, a first lateral side and a second lateral side, said clip being elongated between said first and second lateral sides, said clip being concavely arcuate between said front side and said back side such that said clip forms a tube having said front side being spaced from said back side; and
a plurality of light emitters, each of said light emitters being coupled to said clip wherein each of said light emitters is configured to emit light outwardly therefrom thereby facilitating said light emitters to illuminate a darkened environment; and
a button being movably coupled to said second surface of said clip wherein said button is configured to be manipulated by compression perpendicular to said first and second laterals sides and towards a longitudinal axis of said clip, each of said light emitters being electrically coupled to said button such that said button turns said light emitters on and off.

2. (canceled)

3. The assembly according to claim 1, wherein said clip is comprised of a resiliently bendable material such that said front side is selectively urged away from said back side wherein said clip is configured to receive the tubular structure having said first surface of said clip abutting the tubular structure.

4. The assembly according to claim 1, wherein each of said light emitters is positioned on said second surface of said clip, said light emitters being spaced apart from each other and being distributed on said back side of said clip wherein each of said light emitters is configured to be directed downwardly when said clip is removably attached to the tubular structure.

5. (canceled)

6. The assembly according to claim 1, further comprising a power supply being coupled to said clip, each of said light emitters being electrically coupled to said power supply.

7. The assembly according to claim 6, wherein said power supply comprises at least one battery being positioned between said first surface and said second surface of said clip, each of said light emitters being electrically coupled to said at least one battery.

8. The assembly according to claim 7, further comprising a plurality of solar panels, each of said solar panels being coupled to said clip wherein each of said solar panels is configured to be exposed to sunlight thereby facilitating said solar panels to convert sunlight into electrical current, each of said solar panels being electrically coupled to said at least one battery to charge said at least one battery.

9. The assembly according to claim 8, wherein each of said solar panels is positioned on said second surface of said clip, each of said solar panels being spaced apart from each other and being distributed along said front side of said clip wherein each of said solar panels is configured to be directed upwardly when said clip is removably attached to the tubular structure.

10. A portable illumination assembly being configured to be removably attached to power equipment for employing the power equipment in a dark environment, said assembly comprising:
a clip being configured to engage a tubular structure, said clip having a first surface, a second surface and a peripheral edge extending therebetween, said peripheral edge having a front side, a back side, a first lateral side and a second lateral side, said clip being elongated between said first and second lateral sides, said clip being concavely arcuate between said front side and said back side such that said clip forms a tube having said front side being spaced from said back side, said clip being comprised of a resiliently bendable material such that said front side is selectively urged away from said back side wherein said clip is configured to receive the tubular structure having said first surface of said clip abutting the tubular structure;
a plurality of light emitters, each of said light emitters being coupled to said clip wherein each of said light emitters is configured to emit light outwardly therefrom thereby facilitating said light emitters to illuminate a darkened environment, each of said light emitters being positioned on said second surface of said clip, said light emitters being spaced apart from each other and being distributed on said back side of said clip wherein each of said light emitters is configured to be directed downwardly when said clip is removably attached to the tubular structure;
a button being movably coupled to said second surface of said clip wherein said button is configured to be manipulated by compression perpendicular to said first and second laterals sides and towards a longitudinal axis of said clip, each of said light emitters being electrically coupled to said button such that said button turns said light emitters on and off; and
a power supply being coupled to said clip, each of said light emitters being electrically coupled to said power supply, said power supply comprising:
at least one battery being positioned between said first surface and said second surface of said clip, each of said light emitters being electrically coupled to said at least one battery, and
a plurality of solar panels, each of said solar panels being coupled to said clip wherein each of said solar panels is configured to be exposed to sunlight thereby facilitating said solar panels to convert sunlight into electrical current, each of said solar panels being electrically coupled to said at least one battery to charge said at least one battery, each of said solar panels being positioned on said second surface of said clip, each of said solar panels being spaced apart from each other and being distributed along said front side of said clip wherein each of said solar panels is configured to be directed upwardly when said clip is removably attached to the tubular structure.
